(19) United States
(12) Patent Application Publication
(10) Pub. No.: US 2004/0014881 A1
(43) Pub. Date: Jan. 22, 2004

(54) Single component system setting thermal means or by actinic irradiation and use thereof

(76) Inventors: Hubert Baumgart, Munster (DE); Uwe Meisenburg, Duisburg (DE); Ulrike Rockrath, Senden (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/362,304

(22) PCT Filed: Aug. 22, 2001
(86) PCT No.: PCT/EP01/09697

(30) Foreign Application Priority Data
Aug. 24, 2000 (DE) 100 41 635.7

(51) Int. Cl. B05D 1/36; C08K 3/00

(52) U.S. Cl. 524/589; 427/407.1

(57) ABSTRACT

A one-component system curable with heat and actinic radiation, comprising

(A) at least one crosslinking agent whose molecule contains on average at least one blocked isocyanate group and at least one functional group having at least one bond which may be activated with actinic radiation, and

(B) at least one binder containing on average at least one isocyanate-reactive functional group in the molecule;

and its use as a coating material, adhesive, and sealing compound.

The present invention relates to novel one-component systems curable with both heat and actinic radiation. Furthermore, the present invention relates to the use of the novel one-component systems curable with both heat and actinic radiation as coating materials, adhesives, and sealing compounds.

In the context of the present invention, actinic radiation is electromagnetic radiation such as near infrared (NIR), visible light, UV radiation and X-rays, or corpuscular radiation such as electron beams.

Coating materials, adhesives and sealing compounds curable with both heat and actinic radiation (dual-cure coating materials, adhesives, and sealing compounds) are increasingly gaining in interest since they offer numerous advantages.

Firstly, for instance, dual-cure coating materials are more suited to the coating of heat-sensitive substrates than are coating materials curable by means of heat only, since in the dual-cure systems any incomplete heat-curing at low temperatures may be compensated by curing with actinic radiation, resulting overall in coatings having good performance properties. Secondly, dual-cure coating materials are more suited to coating three-dimensional substrates of complex shape than are coating materials curable with actinic radiation only, since incomplete radiation curing in the shadow regions of the substrates may be compensated by heat-curing, resulting overall, here again, in coatings having good performance properties.

The same applies, mutatis mutandis, to the dual-cure adhesives and sealing compounds as well.

Dual-cure coating materials that give coatings containing urethane groups in their three-dimensional network are known.

European Patent Application EP 0 928 800 A1 discloses a dual-cure coating material comprising a urethane (meth)acrylate containing free isocyanate groups and (meth)acryloyl groups, a photoinitiator, and an isocyanate-reactive compound, especially a polyol or polyamine. This dual-cure coating material offers the possibility of varying the profiles of properties of both coating material and coating and of tailoring them to different end uses.

The disadvantage of the known dual-cure coating materials is that they are two-component systems where the constituents containing free isocyanate groups must prior to application be stored in the absence of water and separately from the constituents containing the isocyanate-reactive groups, in order to prevent premature crosslinking. This, however, necessitates a higher level of technical and planning effort in the context of storage, preparation, and application.

The same applies, mutatis mutandis, to the corresponding dual-cure adhesives and dual-cure sealing compounds, as well.

German Patent Application DE 199 08 018.6, unpublished at the priority date of the present specification, describes a powder slurry curable with heat and actinic radiation which comprises at least one constituent having functional groups which render the slurry curable with actinic radiation and complementary reactive functional groups which render slurry curable with heat, in a molar ratio of from 100:1 to 1:00. Suitable reactive functional groups include urethane groups and urea groups. Crosslinking agents used, however, are conventional crosslinking agents such as tris(alkoxycarbonylamino)triazines, amino resins, compounds containing anhydride groups, compounds containing epoxide groups, blocked and/or unblocked polyisocyanates, beta-hydroxyalkylamides, or adducts of malonic acid derivatives with polyisocyanates in combination with aliphatic dicarboxylic acids. The German patent application does not state that these crosslinking agents are also intended to serve for curing with actinic radiation.

It is an object of the present invention to provide a dual-cure one-component system which possesses the advantages of the known dual-cure two-component systems without having their disadvantages.

In particular, in the novel dual-cure one-component systems, binder and crosslinking agent should be present alongside one another without crosslinking prematurely. Following application, they should crosslink rapidly at comparatively low temperatures under the influence of heat and actinic radiation so that they are also suitable for the coating, bonding, and sealing of thermally sensitive substrates. The resultant novel coatings, adhesive films, and seals ought to have excellent weathering stability, chemical resistance, hardness, flexibility, and scratch resistance, so that they are suitable in particular for automotive OEM finishing, automotive refinishing, furniture coating, and industrial coating, including coil coating, container coating, and the coating of electrical components, and also for the bonding and sealing of the substrates used in these applications.

Accordingly, we have found the novel one-component system curable with both heat and actinic radiation, which comprises

(A) at least one crosslinking agent whose molecule contains on average at least one blocked isocyanate group and at least one functional group having at least one bond which may be activated with actinic radiation, and

(B) at least one binder containing on average at least one isocyanate-reactive functional group,

said system being referred to below as the “one-component system of the invention”.

Further subject matter of the invention will emerge from the description.

The essential constituent of the one-component system of the invention is at least one crosslinking (A) which participates both in heat-curing and in curing with actinic radiation.

The crosslinking agent (A) contains on average at least one, in particular at least two, blocked isocyanate group(s) in the molecule.

Examples of suitable blocking agents for isocyanate groups are

i) phenols such as phenol, cresol, xylenol, nitrophenol, chlorophenol, ethylphenol, tert-butylphenol, hydroxybenzoic acid, esters of this acid, or 2,5-di-tert-butyl-4-hydroxytoluene;

ii) lactams, such as ε-caprolactam, δ-valerolactam, γ-butyrolactam or β-propiolactam;

iii) active methylenic compounds, such as diethyl malonate, dimethyl malonate, ethyl or methyl acetoacetate, or acetylacetone;

iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, propylene glycol monomethyl ether, methoxymethanol, glycolic acid, glycolic esters, lactic acid, lactic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;

v) mercaptans such as butyl mercaptan, hexyl mercaptan, t-butyl mercaptan, t-dodecyl mercaptan, 2-mercaptobenzothiazole, thiophenol, methylthiophenol or ethylthiophenol;

vi) acid amides such as acetoanilide, acetoanisidinamide, acrylamide, methacrylamide, acetamide, stearamide or benzamide;

vii) imides such as succinimide, phthalimide or maleimide;

viii)amines such as diphenylamine, phenylnapthylamine, xylidine, N-phenylxylidine, carbazole, aniline, napthylamine, butylamine, dibutylamine or butylphenylamine;

ix) imidazoles such as imidazole or 2-ethylimidazole;

x) ureas such as urea, thiourea, ethyleneurea, ethylenethiourea or 1,3-diphenylurea;

xi) carbamates such as phenyl N-phenylcarbamate or 2-oxazolidone;

xii) imines such as ethyleneimine;

xiii) oximes such as acetone oxime, formaldoxine, acetaloxime, acetoxime, methyl ethyl ketoxime, diisobutylketoxime, diacetylmonoxime, benzophenone oxime or chlorohexanone oximes;

xiv) salts of sulfurous acid such as sodium bisulfite or potassium bisulfite;

xv) hydroxamic esters such as benzyl methacrylohydroxamate (BMH) or allyl methacrylohydroxamate; or

xvi) substituted pyrazoles, especially dimethyl-pyrazoles, or triazoles; and

xvii) mixtures of these blocking agents, especially dimethylpyrazole and triazoles, malonic esters and acetoacetic esters, or dimethylpyrazole and succinimide.

Moreover, the crosslinking agent (A) contains on average in the molecule at least one, in particular at least two, functional group(s) having at least one bond which may be activated with actinic radiation.

Examples of suitable bonds which may be activated with actinic radiation are carbon-hydrogen single bonds or carbon-carbon, carbon-oxygen, carbon-nitrogen, carbon-phosphorus or carbon-silicon single or double bonds. Of these, the double bonds, especially carbon-carbon double bonds, are used with preference.

Highly suitable carbon-carbon double bonds are present, for example, in (meth)acrylate, ethacrylate, crotonate, cinnamate, vinyl ether, vinyl ester, ethenylarylene, dicyclopentadienyl, norbornenyl, isoprenyl, isopropenyl, allyl, or butenyl groups; dicyclopentadienyl ether, norbornenyl ether, isoprenyl ether, isopropenyl ether, allyl ether, or butenyl ether groups or ethenylarylene ester, dicyclopentadienyl ester, norbornenyl ester, isoprenyl ester, isopropenyl ester, allyl ester or butenyl ester groups. Of these, (meth) acrylate groups, especially acrylate groups, are of particular advantage and are therefore used with very particular preference in accordance with the invention.

The crosslinking agent (A) may be prepared as desired.

Particular advantage is possessed in accordance with the invention, however, by crosslinking agents (A) which are prepared from at least one polyisocyanate having an isocyanate functionality of at least 2.0. Preferably, the polyisocyanate had an isocyanate functionality of from 2.0 and 6.0, preferably from 2.0 to 5.0, with particular preference from 2.0 to 4.5, and in particular from 2.0 to 3.5. With a view to better weathering stability and yellowing resistance, it is preferred to use aliphatic and cycloaliphatic polyisocyanates. In the context of the present invention, a cycloaliphatic diisocyanate is a diisocyanate in which at least one isocyanate group is attached to a cycloaliphatic radical.

Examples of suitable cycloaliphatic polyisocyanates having an isocyanate functionality of 2.0 are isophorone diisocyanate (i.e., 5-isocyanato-1-isocyanatomethyl-1,3,3-trimethylcyclohexane), 5-isocyanato-1-(2-isocyanatoethyl)-1,3,3-trimethylcyclohexane, 5-isocyanato-1-(3-isocyanatoprop-1-yl)-1,3,3-trimethylcyclohexane, 5-isocyanato-4-isocyanatobut-1-yl)-1,3,3-trimethylcyclohexane, 1-isocyanato-2-(3-isocyanatoprop-1-yl)-cyclohexane, 1-isocyanato-2-(3-isocyanatoeth-1-yl)cyclohexane, 1-isocyanato-2-(4-isocyanatobut-1-yl) cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate or dicyclohexylmethane 4,4′-diisocyanate, especially isophorone diisocyanate.

Examples of suitable acyclic aliphatic diisocyanates having an isocyanate functionality of 2.0, for use in accordance with the invention, are trimethylene diisocyanate, tetramethylene diisocyanate, pentamethylene diisocyanate, hexamethylene diisocyanate, ethylethylene diisocyanate, trimethylhexane diisocyanate, heptanemethylene diisocyanate or diisocyanates derived from dimeric fatty acids, as marketed under the commercial designation DDI 1410 by the company Henkel and described in patents WO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis-(3-isocyanatoprop-1-yl)cyclohexane or 1,2-, 1,4- or 1,3-isocyanatobut-1-yl)cyclohexane.

Of these, hexamethylene diisocyanate is of particular advantage and is therefore used with very particular preference in accordance with the invention.

Examples of suitable polyisocyanates (A) having an isocyanate functionality >2 are polyisocyanates, especially those based on hexamethylene diisocyanate, which contain isocyanurate, biuret, allophanate, iminooxadiazinedione, urethane, urea, carbodiimide and/or uretdione groups and which are obtainable in customary and known manner from the diisocyanates described above. Of these, those containing allophanate groups are of advantage and are therefore used with particular preference in accordance with the invention. Examples of suitable preparation processes and polyisocyanates are known, for example, from patents CA 2,163,591 A, U.S. Pat. No. 4,419,513 A, U.S. Pat. No. 4,454,317 A, EP 0 646 608 A1, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A, U.S. Pat. No. 5,290,902 A, EP 0 649 806 A1, DE 42 29 183 A1 and EP 0 531 820 A1 .

The above-described polyisocyanates are reacted with at least one compound containing at least one, especially one, isocyanate-reactive functional group and at least one, especially one, bond which may be activated with actinic radiation.

Examples of suitable isocyanate-reactive functional groups are hydroxyl, thiol and/or primary and/or secondary amino groups, especially hydroxyl groups.

Examples of suitable bonds which may be activated with actinic radiation are those described above.

Examples of suitable compounds containing per molecule at least one, especially one, isocyanate-reactive functional group and at least one, especially one, bond which may be activated with actinic radiation are

allyl alcohol or 4-butyl vinyl ether;

hydroxyalkyl and hydroxycycloalkyl esters of acrylic acid or of methacrylic acid, especially of acrylic acid, which are obtainable by esterifying aliphatic diols, for example, the low molecular mass diols B) described above, with acrylic acid or methacrylic acid or by reacting acrylic or methacrylic acid with an alkylene oxide, especially hydroxyalkyl esters of acrylic acid or methacrylic acid in which the hydroxyalkyl group contains up to 20 carbon atoms, such as 2-hydroxyethyl, 2-hydroxypropyl, 3-hydroxypropyl, 3-hydroxybutyl, 4-hydroxybutyl or bis(hydroxymethyl)cyclohexane acrylate or methacrylate; of these, 2-hydroxyethyl acrylate and 4-hydroxybutyl acrylate are particularly advantageous and are therefore used with particular preference in accordance with the invention; or

reaction products of cyclic esters, such as epsilon-caprolactone, for example, and these hydroxyalkyl or hydroxycycloalkyl esters.

Moreover, the polyisocyanates are reacted with at least one of the above-described blocking agents.

In a first preferred variant, the crosslinking agent (A) is prepared by reacting the above-described compounds with the polyisocyanates in a molar ratio such that on average there remains in the resultant adduct at least one free isocyanate group which is available for reaction with the above-described blocking agents.

In a second preferred variant, the crosslinking agent (A) is prepared by reacting the above-described blocking agents with the polyisocyanates in a molar ratio such that on average there remains in the adduct at least one free isocyanate group which is available for reaction with the above-described compounds.

In a third preferred variant, the crosslinking agent (A) is prepared by reacting the above-described compounds and the above-described blocking agents with the polyisocyanates in a one-pot process.

Irrespective of which variant is chosen to prepare the crosslinking agent (A), no free isocyanate groups are present or detectable therein any longer.

The amount of the crosslinking agent (A) in the one-component system of the invention may vary widely and is guided primarily by the functionality of the crosslinking agent (A) on the one hand and the functionality of the binder (B) on the other. Based on its solids, the one-component system of the invention preferably contains from 10 to 80, more preferably from 15 to 75, with particular preference from 20 to 70, with very particular preference from 25 to 65, and in particular from 30 to 60% by weight.

The further essential constituent of the one-component system of the invention is at least one binder (B) whose molecule contains on average at least one, in particular at least two, isocyanate-reactive functional group(s). Examples of suitable isocyanate-reactive functional groups are those described above. The binder (B) may additionally contain at least one, in particular at least two, of the above-described functional groups having at least one bond which may be activated with actinic radiation.

Examples of suitable binders (B) are random, alternating and/or block linear and/or branched and/or comb (co)polymers of ethylenically unsaturated monomers, polyaddition resins and/or polycondensation resins. For further details of these terms, reference is made to Römpp Lexikon Lacke und Druckfarben, Georg Thieme Verlag, Stuttgart, New York, 1998, page 457, “Polyaddition” and “Polyaddition resins (polyadducts)”, and also pages 463 and 464, “Polycondensates”, “Polycondensation”, and “Polycondensation resins”, and pages 73 and 74, “Binders”.

Examples of suitable (co)polymers are (meth)acrylate (co)polymers or partially hydrolyzed polyvinyl esters, especially (meth)acrylate copolymers.

Examples of suitable polyaddition resins and/or polycondensation resins are polyesters, alkyds, polyurethanes, polylactones, polycarbonates, polyethers, epoxy resin-amine adducts, polyureas, polyamides, polyimides, polyester-polyurethanes, polyether-polyurethanes or polyester-polyether-polyurethanes, especially polyester-polyurethanes.

Of these binders (B), the (meth)acrylate copolymers have particular advantages and are therefore used with particular preference.

Examples of suitable olefinically unsaturated monomers (b) for preparing the (meth)acrylate copolymers (B) are

(b1) monomers bearing at least one hydroxyl or amino group per molecule, such as

hydroxyalkyl esters of acrylic acid, methacrylic acid or another alpha,beta-olefinically unsaturated carboxylic acid, which are derived from an alkylene glycol which is esterified with the acid, or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate, crotonate, maleate, fumarate or itaconate; or hydroxycycloalkyl esters such as 1,4-bis(hydroxymethyl)cyclohexane, octahydro-4,7-methano-1H-indenedimethanol or methylpropanediol monoacrylate, monomethacrylate, monoethacrylate, monocrotonate, monomaleate, monofumarate or monoitaconate; reaction products of cyclic esters, such as epsilon-caprolactone, for example, and these hydroxyalkyl or hydroxycycloalkyl esters;

olefinically unsaturated alcohols such as allyl alcohol;

polyols such as trimethylolpropane monoallyl or diallyl ether or pentaerythritol monoallyl, diallyl or triallyl ether;

reaction products of acrylic acid and/or methacrylic acid with the glycidyl ester of an alpha-branched monocarboxylic acid of 5 to 18 carbon atoms per molecule, especially a Versatic® acid, or, instead of the reaction product, an equivalent amount of acrylic and/or methacrylic acid which is then reacted during or after the polymerization reaction with the glycidyl ester of an alpha-branched monocarboxylic acid of 5 to 18 carbon atoms per molecule, especially a Versatic® acid;

aminoethyl acrylate, aminoethyl methacrylate, allylamine or N-methyliminoethyl acrylate; and/or

acryloyloxysilane-containing vinyl monomers, preparable by reacting hydroxy-functional silanes with epichlorohydrin and then reacting the reaction product with (meth)acrylic acid and/or hydroxyalkyl and/or hydroxycycloalkyl esters of (meth)acrylic acid and/or further hydroxyl-containing monomers (b1).

(b2) Monomers which carry at least one acid group per molecule, such as

acrylic acid, methacrylic acid, ethacrylic acid, crotonic acid, maleic acid, fumaric acid or itaconic acid;

olefinically unsaturated sulfonic or phosphonic acids or their partial esters;

mono(meth)acryloyloxyethyl maleate, succinate or phthalate; or

vinylbenzoic acid (all isomers), alphamethylvinylbenzoic acid (all isomers) or vinylbenzenesulfonic acid (all isomers).

(b3) Monomers which are essentially or completely free from reactive functional groups, such as:

Monomers (b31):

(Meth)acrylic esters which are essentially free from acid groups, such as (meth)acrylic alkyl or cycloalkyl esters having up to 20 carbon atoms in the alkyl radical, especially methyl, ethyl, propyl, n-butyl, sec-butyl, tert-butyl, hexyl, ethylhexyl, stearyl and lauryl acrylate or methacrylate; cycloaliphatic (meth)acrylic esters, especially cyclohexyl, isobornyl, dicyclopentadienyl, octahydro-4,7-methano-1H-indenemethanol or tert-butylcyclohexyl (meth)acrylate; (meth)acrylic oxaalkyl or oxacycloalkyl esters such as ethoxytriglycol (meth)acrylate and methoxyoligoglycol (meth)acrylate having a molecular weight Mn of preferably 550 or other ethoxylated and/or propoxylated, hydroxyl-free (meth)acrylic acid derivatives (further examples of suitable monomers (b31) of this kind are known from the laid-open specification DE 196 25 773 A1, column 3 line 65 to column 4 line 20). In minor amounts they may contain higher-functional (meth)acrylic alkyl or cycloalkyl esters such as ethylene glycol, propylene glycol, diethylene glycol, dipropylene glycol, butylene glycol, 1,5-pentanediol, 1,6-hexanediol, octahydro-4,7-methano-1H-indenedimethanol or cyclohexane-1,2-, -1,3- or -1,4-diol di(meth)acrylate; trimethylolpropane di- or tri(meth)acrylate; or pentaerythritol di-, tri- or tetra(meth)acrylate. Context of the present invention, minor amounts of higher-functional monomers (b31) are amounts which do not lead to crosslinking or gelling of the copolymers, unless the intention is that they should be present in the form of crosslinked microgel particles.

Monomers (b32):

Vinyl esters of alpha-branched monocarboxylic acids having 5 to 18 carbon atoms in the molecule. The branched monocarboxylic acids may be obtained by reacting formic acid or carbon monoxide and water with olefins in the presence of a liquid, strongly acidic catalyst; the olefins may be cracking products of paraffinic hydrocarbons, such as mineral oil fractions, and may comprise branched and straight-chain acyclic and/or cycloaliphatic olefins. The reaction of such olefins with formic acid or with carbon monoxide and water produces a mixture of carboxylic acids in which the carboxyl groups are located predominantly on a quaternary carbon atom. Other olefinic starting materials are, for example, propylene trimer, propylene tetramer and diisobutylene. Alternatively, the vinyl esters may be prepared in a conventional manner from the acids; for example, by reacting the acid with acetylene. Particular preference, owing to their ready availability, is given to the use of vinyl esters of saturated aliphatic monocarboxylic acids having 9 to 11 carbon atoms which are branched on the alpha carbon atom. Vinyl esters of this kind are sold under the brand name VeoVa® (cf. also Römpp Lexikon Lacke und Druckfarben, Georg Thieme Verlag, Stuttgart, New York, 1998, page 598).

Monomers (b33):

Diarylethylenes, especially those of the general formula I:

R¹R²C═CR³R⁴ (I),

in which the radicals R¹, R², R³ and R⁴ in each case independently of one another are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals. Examples of suitable alkyl radicals are methyl, ethyl, propyl, isopropyl, n-butyl, isobutyl, tert-butyl, amyl, hexyl or 2-ethylhexyl. Examples of suitable cycloalkyl radicals are cyclobutyl, cyclopentyl or cyclohexyl. Examples of suitable alkylcycloalkyl radicals are methylenecyclohexane, ethylenecyclohexane or propane-1,3-diylcyclohexane. Examples of suitable cycloalkylalkyl radicals are 2-, 3- or 4-methyl-, -ethyl-, -propyl- or -butylcyclohex-1-yl. Examples of suitable aryl radicals are phenyl, naphthyl or biphenylyl, preferably phenyl and naphthyl and especially phenyl. Examples of suitable alkylaryl radicals are benzyl or ethylene- or propane-1,3-diylbenzene. Examples of suitable cycloalkylaryl radicals are 2-, 3- or 4-phenylcyclohex-1-yl. Examples of suitable arylalkyl radicals are 2-, 3- or 4-methyl-, -ethyl-, -propyl- or -butylphen-1-yl. Examples of suitable arylcycloalkyl radicals are 2-, 3- or 4-cyclohexylphen-1-yl. The aryl radicals R¹, R², R³ and/or R⁴ are preferably phenyl or naphthyl radicals, especially phenyl radicals. The substituents that may be present in the radicals R¹, R², R³ and/or R⁴ are electron-withdrawing or electron-donating atoms or organic radicals, especially halogen atoms, nitrile, nitro, partially or fully halogenated alkyl, cycloalkyl, alkylcycloalkyl, cycloalkylalkyl, aryl, alkylaryl, cycloalkylaryl, arylalkyl and arylcycloalkyl radicals; aryloxy, alkyloxy and cycloalkyloxy radicals; and/or arylthio, alkylthio and cycloalkylthio radicals. Diphenylethylene, dinaphthaleneethylene, cis- or trans-stilbene, vinylidenebis(4-nitrobenzene), especially diphenylethylene (DPE), are particularly advantageous and so are used with preference. In the context of the present invention, the monomers (b33) are used in order to regulate the copolymerization advantageously such that batchwise free-radical copolymerization is also possible.

Monomers (b34):

Vinylaromatic hydrocarbons such as styrene, vinyltoluene, diphenylethylene or alpha-alkylstyrenes, especially alpha-methylstyrene.

Monomers (b35):

Nitriles such as acrylonitrile and/or methacrylonitrile.

Monomers (b36):

Vinyl compounds, especially vinyl halides and/or vinylidene dihalides, such as vinyl chloride, vinyl fluoride, vinylidene dichloride or vinylidene difluoride; N-vinyl amides such as vinyl-N-methylformamide, N-vinylcaprolactam or N-vinylpyrrolidone; 1-vinylimidazole; vinyl ethers such as ethyl vinyl ether, n-propyl vinyl ether, isopropyl vinyl ether, n-butyl vinyl ether, isobutyl vinyl ether and/or vinyl cyclohexyl ether; and/or vinyl esters such as vinyl acetate, vinyl propionate, vinyl butyrate, vinyl pivalate and/or the vinyl ester of 2-methyl-2-ethylheptanoic acid.

Monomers (b37):

Allyl compounds, especially allyl ethers and allyl esters such as allyl methyl, ethyl, propyl or butyl ether or allyl acetate, propionate or butyrate.

Monomers (b38):

Polysiloxane macromonomers having a number-average molecular weight Mn of from 1000 to 40,000 and having on average from 0.5 to 2.5 ethylenically unsaturated double bonds per molecule; especially polysiloxane macromonomers having a number-average molecular weight Mn of from 2000 to 20,000, with particular preference from 2500 to 10,000, and in particular from 3000 to 7000 and having on average from 0.5 to 2.5, preferably from 0.5 to 1.5, ethylenically unsaturated double bonds per molecule, as are described in DE 38 07 571 A1 on pages 5 to 7, in DE 37 06 095 A1 in columns 3 to 7, in EP 0 358 153 B1 on pages 3 to 6, in U.S. Pat. No. 4,754,014 A1 in columns 5 to 9, in DE 44 21 823 A1 or in International Patent Application WO 92/22615 on page 12 line 18 to page 18 line 10.

Monomers (b39):

Olefins such as ethylene, propylene, but-1-ene, pent-1-ene, hex-1-ene, cyclohexene, cyclopentene, norbornene, butadiene, isoprene, cyclopentadiene and/or dicyclopentadiene.

and /or

(b4) Monomers containing epoxide groups, such as the glycidyl ester of acrylic acid, methacrylic acid, ethacrylic acid, crotonic acid, maleic acid, fumaric acid or itaconic acid, or allyl glycidyl ether.

Higher-functional monomers of the type described above are generally used in minor amounts. In the context of the present invention, minor amounts of higher-functional monomers are those amounts which do not lead to crosslinking or gelling of the (meth)acrylate copolymers (B), unless the specific aim is to prepare crosslinked polymeric microparticles.

Examples of suitable preparation processes for (meth)acrylate copolymers (B) are described in European Patent Applications EP 0 767 185 A1, in German Patents DE 22 14 650 B1 and DE 27 49 576 B1, and in the American Patents U.S. Pat. No. 4,091,048 A1, U.S. Pat. No. 3,781,379 A1, U.S. Pat. No. 5,480,493 A1, U.S. Pat. No. 5,475,073 A1 and U.S. Pat. No. 5,534,598 A1, and in the standard work Houben-Weyl, Methoden der organischen Chemie, 4th Edition, volume 14/1, pages 24 to 255, 1961. Suitable reactors for the copolymerization are the customary and known stirred vessels, cascades of stirred vessels, tube reactors, loop reactors or Taylor reactors, as described for example in patents and patent application DE 1 071 241 B1, EP 0 498 583 A1 and DE 198 28 742 A1 and in the article by K. Kataoka in Chemical Engineering Science, volume 50, number 9, 1995, pages 1409 to 1416.

Functional groups having at least one bond that may be activated by actinic radiation may be introduced by polymer-analogous reaction of the above-described (meth)acrylate copolymers (B) with appropriate compounds containing bonds that may be activated by actinic radiation. For example, any pendant glycidyl groups that may be present on the (meth)acrylate copolymers (B) may be reacted with (meth)acrylic acid.

The amount of the binders (B) in the one-component system of the invention may vary widely and is guided primarily by the functionality of the binders (B) on the one hand and of the crosslinking agents (A) on the other. The amount, based on the solids of the one-component system of the invention, is preferably from 20 to 90, more preferably from 25 to 85, with particular preference from 30 to 80, with very particular preference from 35 to 75, and in particular from 40 to 70% by weight.

The one-component system of the invention may comprise at least one additive (C). The selection is guided primarily by the intended use of the one-component system of the invention.

For instance, the one-component system of the invention may be used as a dual-cure adhesive, dual-cure sealing compound, or dual-cure coating material. Moreover, it may be used for preparing these products. The dual-cure adhesives, sealing compounds and coating materials may be solventborne liquid systems (conventional systems), solvent-free liquid systems (100% systems), or solvent-free solid systems. In the case of coating materials, the solvent-free solid systems are also known as powder coating materials. They may also be present as a dispersion in water. Dispersions of this kind are referred to by those in the art, inter alia, as powder slurry coating materials. Preference is given to the use of solventborne liquid—i.e., conventional—dual-cure adhesives, sealing compounds, and coating materials. Relative to customary and known adhesives, sealing compounds, and coating materials, those of the invention have the advantage of a significantly higher solids content.

The one-component system of the invention has particular advantages when used as a dual-cure coating material. The coating material in question may be a pigmented or an unpigmented coating material. Examples of pigmented coating materials are surfacers, solid-color topcoats or basecoats; examples of unpigmented coating materials are clearcoats. With particular preference, the one-component systems of the invention is used as or to prepare dual-cure clearcoats, especially conventional dual-cure clearcoats.

If the dual-cure coating material is used as a surfacer, solid-color topcoat or basecoat, it includes color and/or effect pigments (C) as additives (C) in customary and known amounts. The pigments (C) may comprise organic and inorganic compounds and may provide effect and/or color. On the basis of this large number of suitable pigments (C), therefore, the dual-cure coating material of the invention is assured a universal breadth of application and permits the realization of a large number of color shades and optical effects.

Effect pigments (C) which may be used include metal flake pigments such as commercial aluminum bronzes, aluminum bronzes chromated in accordance with DE 36 36 183 A1, and commercial stainless steel bronzes, and also nonmetallic effect pigments, such as pearlescent pigments and interference pigments, for example. For further details, reference is made to Römpp Lexikon Lacke und Druckfarben, Georg Thieme Verlag, 1998, pages 176, “Effect pigments”, and pages 380 and 381, “Metal oxide-mica pigments” to “Metal pigments”.

Examples of suitable inorganic color pigments (C) are titanium dioxide, iron oxides, Sicotrans yellow and carbon black. Examples of suitable organic color pigments are thioindigo pigments, indanthrene blue, Cromophthal red, Irgazine orange and Heliogen green. For further details, reference is made to Römpp Lexikon Lacke und Druckfarben, Georg Thieme Verlag, 1998, pages 180 and 181, “Iron blue pigments” to “Black iron oxide”, pages 451 to 453, “Pigments” to “Pigment volume concentration”, page 563, “Thioindigo pigments”, and page 567, “Titanium dioxide pigments”.

Furthermore, the dual-cure coating material especially as a surfacer, may comprise organic and inorganic fillers (C) in customary and known, effective amounts. Examples of suitable fillers (C) are chalk, calcium sulfate, barium sulfate, silicates such as talc or kaolin, silicas, oxides such as aluminum oxide or magnesium hydroxide or organic fillers such as textile fibers, cellulose fibers, polyethylene fibers or wood flour. For further details, reference is made to Römpp Lexikon Lacke und Druckfarben, Georg Thieme Verlag, 1998, pages 250 ff., “Fillers”.

These pigments and fillers (C) may also be incorporated into the dual-cure coating materials by way of pigment pastes.

The above-described pigments and fillers (C) are omitted if the dual-cure coating materials are used in their especially preferred utility as clearcoats.

Examples of suitable additives (C) which may be present in the clearcoats, surfacers, basecoats, and solid-color topcoats are

heat-curable reactive diluents such as positionally isomeric diethyloctanediols or hydroxyl-containing hyperbranched compounds or dendrimers, as described in German Patent Applications DE 198 05 421 A1, DE 198 09 643 A1, and DE 198 40 405 A1;

reactive diluents curable with actinic radiation, such as those described in Römpp Lexikon Lacke und Druckfarben, Georg Thieme Verlag, Stuttgart, New York, 1998, on page 491 under the heading “Reactive diluents”;

additional crosslinking agents such as resins or compounds containing anhydride groups, resins or compounds containing epoxide groups, tris(alkoxycarbonylamino)triazines, resins or compounds containing carbonate groups, blocked and/or unblocked polyisocyanates, beta-hydroxyalkylamides, and compounds containing on average at least two groups capable of transesterification, examples being reaction products of malonic diesters and polyisocyanates or of esters and partial esters of polyhydric alcohols of malonic acid with monoisocyanates, as described in European Patent EP 0 596 460 A1;

low-boiling and/or high-boiling organic solvents (“long solvents”);

UV absorbers;

light stabilizers such as HALS compounds, benzotriazoles or oxalanilides;

free-radical scavengers;

photoinitiators such as those of the Norrish II type, whose mechanism of action is based on an intramolecular variant of the hydrogen abstraction reactions, as occur diversely in photochemical reactions (reference may be made here by way of example to Römpp Chemie Lexikon, 9th, expanded and revised edition, Georg Thieme Verlag, Stuttgart, Vol. 4, 1991) or cationic photoinitiators (reference may be made here, by way of example, to Römpp Lexikon Lacke und Druckfarben, Georg Thieme Verlag, Stuttgart, 1998, pages 444 to 446), especially benzophenones, benzoins or benzoin ethers or phosphine oxides;

thermally labile free-radical initiators such as organic peroxides, organic azo compounds or C—C-cleaving initiators, such as dialkyl peroxides, peroxocarboxylic acids, peroxodicarbonates, peroxide esters, hydroperoxides, ketone peroxides, azo dinitriles, or benzpinacol silyl ethers; in the presence of these thermally labile free-radical initiators, the dual-cure coating material of the invention may also be cured by means of heat alone, which is a further particular advantage;

crosslinking catalysts such as dibutyltin dilaurate, dibutyltin dioleate, lithium decanoate, bismuth lactate or dimethylpropionate, or zinc octoate or strong acids such as sulfonic acids, which may have been blocked with amines;

devolatilizers, such as diazadicycloundecane;

slip additives;

polymerization inhibitors;

defoamers;

emulsifiers, especially nonionic emulsifiers such as alkoxylated alkanols, polyols, phenols and alkylphenols, or anionic emulsifiers such as alkali metal salts or ammonium salts of alkanecarboxylic acids, alkanesulfonic acids, and sulfo acids of alkoxylated alkanols, polyols, phenols and alkylphenols;

wetting agents such as siloxanes, fluorine compounds, carboxylic monoesters, phosphoric esters, polyacrylic acids and their copolymers, or polyurethanes;

adhesion promoters such as tricyclodecanedimethanol;

leveling agents;

film-forming auxiliaries such as cellulose derivatives;

transparent fillers based on silica, aluminum oxide or zirconium oxide; for further details reference is also made to Römpp Lexikon Lacke und Druckfarben, Georg Thieme Verlag, Stuttgart, 1998, pages 250 to 252; the fillers may also be present as nanoparticles and are preferably present in dispersion in the above-described reactive diluents for curing with actinic radiation;

sag control agents such as ureas, modified ureas and/or silicas, as described for example in the references EP 192 304 A1, DE 23 59 923 A1, DE 18 05 693 A1, WO 94/22968, DE 27 51 761 C1, WO 97/12945 or “farbe+lack”, 11/1992, pages 829 ff.;

rheology control additives, such as those known from patents WO 94/22968, EP 0 276 501 A1, EP 0 249 201 A1 or WO 97/12945; crosslinked polymeric microparticles; inorganic phyllosilicates such as aluminum magnesium silicates, sodium magnesium and sodium-magnesium-fluorine-lithium phyllosilicates of the montmorillonite type; silicas such as Aerosils; or synthetic polymers containing ionic and/or associative groups such as polyvinyl alcohol, poly(meth)acrylamide, poly(meth)acrylic acid, polyvinylpyrrolidone, styrene-maleic anhydride or ethylene-maleic anhydride copolymers and their derivatives or hydrophobically modified ethoxylated urethanes or polyacrylates;

flame retardants, and/or

flatting agents such as magnesium stearate.

Further examples of suitable additives (C) are described in the textbook “Lackadditive” by Johan Bieleman, Wiley-VCH, Weinheim, New York, 1998.

The additives (C) described above may also be present in the dual-cure adhesives and sealing compounds, provided they are suitable for these uses, which is something readily determinable by the skilled worker on the basis of his or her general knowledge in the art.

The preparation of the one-component systems of the invention has no special features but instead takes place in a customary and known manner by mixing of the above-described constituents in appropriate mixing apparatus such as stirred vessels, dissolvers, stirred mills, or extruders, in accordance with the processes suitable for preparing the respective dual-cure coating materials, adhesives, or sealing compounds of the invention.

The dual-cure adhesives are used to produce the adhesive films of the invention on primed and unprimed substrates.

The dual-cure sealing compounds of the invention are used to produce the seals of the invention on and/or in primed and unprimed substrates.

The dual-cure coating materials are used to produce single-coat or multicoat clearcoat systems and/or multicoat color and/or effect systems on primed and unprimed substrates. It is in this utility in particular that the one-component systems of the invention prove particularly advantageous. Very special advantages result when they are used to produce clearcoats, especially as part of what is known as the wet-on-wet technique, in which a basecoat material, especially an aqueous basecoat material, is applied to the primed or unprimed substrate and dried but not cured, a clearcoat material is then applied to the basecoat film, and the resultant clearcoat film is cured together with the basecoat film, by means of heat and actinic radiation.

Suitable coating substrates are all surfaces which are not damaged by curing of the films present thereon by the combined application of heat and actinic radiation.

Suitable substrates comprise metals, plastics, wood, ceramic, stone, textile, fiber composites, leather, glass, glass fibers, glass wool, rock wool, mineral-bound and resin-bound building materials, such as plasterboards and cement slabs or roof tiles, and assemblies of these materials.

Accordingly, the coatings, adhesive films or seals of the invention are also suitable for applications outside of the OEM finishing and refinishing of automobiles. They are particularly suitable for the coating, bonding and/or sealing of furniture, windows and doors, of interior and exterior constructions, and for industrial coating, including coil coating, container coating, and the impregnation or coating of electrical components. In the context of industrial coating, they are suitable for the coating, bonding and/or sealing of virtually all parts for private or industrial use, such as radiators, domestic appliances, small metal parts such as nuts and bolts, hubcaps, wheel rims, packaging, or electrical components such as motor windings or transformer windings.

In the case of electrically conductive substrates it is possible to use primers produced in a customary and known manner from electrodeposition coating materials. Both anodic and cathodic electrodeposition coating materials, but especially cathodics, are suitable for this purpose.

It is also possible to coat, bond or seal primed or unprimed plastics parts made, for example, of ABS, AMMA, ASA, CA, CAB, EP, UF, CF, MF, MPF, PF, PAN, PA, PE, HDPE, LDPE, LLDPE, UHMWPE, PC, PC/PBT, PC/PA, PET, PMMA, PP, PS, SB, PUR, PVC, RF, SAN, PBT, PPE, POM, PUR-RIM, SMC, BMC, PP-EPDM and UP (abbreviations to DIN 7728P1). Unfunctionalized and/or nonpolar substrate surfaces may be subjected prior to coating in a known manner to a pretreatment, such as with a plasma or by flaming, or provided with a water-based primer.

The dual-cure coating materials, adhesives, and sealing compounds, especially the dual-cure coating materials, may be applied by any customary application method, such as spraying, knife coating, brushing, flow coating, dipping, impregnating, trickling, or rolling, for example. The substrate to be coated may itself be at rest, with the application equipment or unit being moved. Alternatively, the substrate to be coated, especially a coil, may be moved, with the application unit being at rest relative to the substrate or being moved in an appropriate manner.

It is preferred to employ spray application methods, such as compressed-air spraying, airless spraying, high-speed rotation, electrostatic spray application (ESTA), alone or together with hot spray application such as hot air spraying, for example. Application may be made at temperatures of max. 70 to 80° C., so that appropriate application viscosities are achieved without the brief thermal exposure causing a change or damage to the coating material or to its overspray, which may be intended for recycling. For instance, hot spraying may be configured such that the dual-cure coating material is heated only very briefly in the spray nozzle or shortly before the spray nozzle.

The spray booth used for application may, for example, be operated with a circulation system, which may be temperature-controllable, and which is operated with an appropriate absorption medium for the overspray, an example of such medium being the coating material itself.

Application is preferably conducted under illumination with visible light of a wavelength of above 550 nm or in the absence of light. By this means, material alteration or damage to the dual-cure coating material and to the overspray is avoided.

In general, the surfacer film, solid-color topcoat film, basecoat film, and clearcoat film are applied in a wet-film thickness such that curing thereof results in coats having the thicknesses that are advantageous and necessary for their functions. In the case of the surfacer coat this thickness is from 10 to 150, preferably from 15 to 120, with particular preference from 20 to 100, and in particular from 25 to 90 μm, in the case of the solid-color topcoat it is from 5 to 90, preferably from 10 to 80, with particular preference from 15 to 60, and in particular from 20 to 50 μm, in the case of the basecoat it is from 5 to 50, preferably from 6 to 40, with particular preference from 7 to 30, and in particular from 8 to 25 μm, and in the case of the clearcoats it is from 10 to 100, preferably from 15 to 80, with particular preference from 20 to 70, and in particular from 20 to 60 μm.

Curing may take place after a certain rest period. This period may have a duration of from 30 s to 2 h, preferably from 1 min to 1 h, and in particular from 1 min to 30 min. The rest period is used, for example, for leveling and devolatilization of the applied films or for the evaporation of volatile constituents such as solvent or water. The rest period may be shortened and/or assisted by the application of elevated temperatures up to 80° C., provided this does not entail any damage or alteration to the applied films, such as premature complete crosslinking.

In accordance with the invention, curing takes place with actinic radiation, in particular with UV radiation, and/or electron beams. If desired, it may be supplemented or carried out with actinic radiation from other radiation sources. In the case of electron beams it is preferred to operate under an inert gas atmosphere. This may be ensured, for example, by supplying carbon dioxide and/or nitrogen directly to the surface of the applied films.

In the case of UV radiation curing as well it is possible to operate under inert gas in order to prevent the formation of ozone.

Actinic radiation curing is carried out using the customary and known radiation sources and optical auxiliary measures. Examples of suitable radiation sources are high- and low-pressure mercury vapor lamps, with or without lead doping in order to open up a radiation window up to 405 nm, or electron beam sources. Their arrangement is known in principle and may be adapted to the circumstances of the workpiece and the process parameters. In the case of workpieces of complex shape such as automobile bodies, those regions not accessible to direct radiation (shadow regions) such as cavities, folds and other structural undercuts, may be cured using point, small-area or all-around radiation sources, in conjunction with an automatic movement means for the irradiation of cavities or edges.

The equipment and conditions for these curing methods are described, for example, in R. Holmes, U.V. and E.B. Curing Formulations for Printing Inks, Coatings and Paints, SITA Technology, Academic Press, London, United Kingdom 1984.

Curing here may take place in stages, i.e., by multiple exposure to light or actinic radiation. It may also take place in alternation, i.e., by curing alternately with UV radiation and electron beams.

The heat-curing as well has no special features in terms of its method but instead takes place in accordance with the customary and known methods such as heating in a convection oven or irradiation with IR lamps. Heat-curing may also take place in stages as with curing with actinic radiation. Advantageously, it is effected at a temperature >90° C., preferably from 90 to 180° C., with particular preference from 110 to 160° C., and in particular from 120 to 150° C. for a period of from 1 min to 2 h, with particular preference from 2 min to 1 h, and in particular from 3 min to 30 min.

Heat-curing and curing with actinic radiation may be employed simultaneously or alternately. If the two curing methods are used in alternation, it is possible, for example, to begin with heat-curing and to end with actinic radiation curing. In other cases it may be found advantageous to begin with actinic heat-curing and to end with it. The skilled worker is able to choose the most advantageous curing method for the particular case in question on the basis of his or her general knowledge of the art, possibly with the assistance of simple preliminary tests.

The adhesive films and seals of the invention produced from the dual-cure adhesives and sealing compounds of the invention possess outstanding bond strength and sealing capacity even over long periods of time and even under extreme and/or rapidly changing climatic conditions.

The coatings of the invention produced from the dual-cure coating materials of the invention exhibit outstanding leveling and an outstanding overall visual impression. They are stable to weathering and do not yellow even in a tropical climate. They are therefore suitable for interior and exterior use.

As far as color, effect, gloss, and DOI (distinctiveness of the reflected image) are concerned, the multicoat color and/or effect systems produced using the dual-cure coating materials are of the highest optical quality, have a smooth, untextured, hard, flexible and scratch-resistant surface, are weathering-, chemical- and etch-resistant, do not yellow, and exhibit no film cracking or delamination.

Consequently, the primed and unprimed substrates of the invention, especially bodies of automobiles and commercial vehicles, industrial components, including plastics parts, packaging, coils, and electrical components, or furniture, which have been coated with at least one coating of the invention, sealed with at least one seal of the invention, and/or bonded with at least one adhesive of the invention, therefore have particular technical and economic advantages, in particular a long service life, which makes them particularly attractive to users.

### EXAMPLE

### Preparation Example 1

### The preparation of a Binder (B)

A laboratory reactor having a useful volume of 4 l and equipped with a stirrer, a dropping funnel for the monomer feed and a dropping funnel for the initiator feed, nitrogen inlet pipe, thermometer, and reflux condenser, was charged with 650 parts by weight of a fraction of aromatic hydrocarbons having a boiling range from 158 to 172° C. The solvent was heated to 140° C., after which a monomer mixture of 652 parts by weight of ethylhexyl acrylate, 383 parts by weight of hydroxyethyl methacrylate, 143 parts by weight of styrene, 213 parts by weight of 4-hydroxybutyl acrylate and 49 parts by weight of acrylic acid, and an initiator solution of 113 parts by weight of tert-butyl perethylhexanoate and 113 parts by weight of the aromatic solvent, were metered in at this temperature and at a uniform rate, with stirring, addition of the monomer mixture taking place over four hours and of the initiator solution over four and a half hours. The feeds were commenced simultaneously. After the end of the initiator feed, the editing mixture was held at 140° C. for two hours and subsequently cooled. The reaction mixture was diluted with a mixture of 1-methoxypropyl 2-acetate, butyl glycol acetate and butyl acetate. The resultant binder solution had a solids content of 65% by weight (1 h/130° C.).

### Preparation Example 2

The preparation of a Crosslinking Agent (A) for Use in Accordance with the Invention

1538 parts by weight of a commercial acrylate- and isocyanate-functional polyisocyanate (Roskydal® UA VPLS 2337 from Bayer AG) were dissolved in 838 parts by weight of an aromatic hydrocarbon fraction having a boiling range of 158 to 172° C. The solution was weighed out into a reactor equipped with stirrer, reflux condenser and oil heating and was heated to 60° C. 418 parts by weight of dimethylpyrazole were added in three portions via a solid metering device, an exothermic reaction occurring on each addition. Following each of the additions, the subsidence of the exothermic reaction was awaited before the next addition was made. The amount of free isocyanate groups was determined hourly. At an isocyanate content <0.01%, the solution was cooled to room temperature and filtered. The solution had a solids content of 70% by weight.

### Example 1

### The Preparation of a Dual-cure Clearcoat Material of the Invention

The dual-cure clearcoat material of the invention was prepared by mixing 41.3 parts by weight of the binder solution of Preparation Example 1, 39.2 parts by weight of the crosslinking agent solution of Preparation Example 2, 0.65 part by weight of a substituted hydroxyphenyltriazine (65% strength in toluene), 0.58 part by weight of N-amino ether 2,2,6,6-tetramethylpiperidinyl ester (Tinuvin® 123 from Ciba Specialty Chemicals), 0.25 part by weight of Lucirin® TPO (photoinitiator from BASF Aktiengesellschaft), 2.4 parts by weight of Genocure® MBF (photoinitiator from Rahn), 11 parts by weight of solvent naphtha, 4 parts by weight of butyl diglycol acetate and 0.1 part by weight of Dow Corning Pa 57 (additive from Dow Corning GmbH).

For application, the clearcoat material was adjusted, using a mixture of solvent naphtha and butyl diglycol acetate in a volume ratio of 1:1, to a viscosity of 30 seconds in the DIN4 efflux cup.

### Example 2

### The Production of a Multicoat System of the Invention

To produce the multicoat system, steel test panels coated with an electrodeposition coating in a dry-film thickness of from 18 to 22 μm were coated with an aqueous surfacer. The resultant aqueous surfacer film was baked at 160° C. for 20 minutes to give a surfacer coat with a dry-film thickness of from 35 to 40 μm. The surfacer coat was subsequently coated with a black aqueous basecoat material in a film thickness of from 12 to 15 μm, and the resultant aqueous basecoat films was flashed off at 80° C. for 10 minutes. Thereafter, the clearcoat material of Example 1 was applied pneumatically in one cross-pass using a gravity-feed gun, in a film thickness of from 40 to 45 μm. Thereafter, the clearcoat film was flashed off at room temperature for 10 minutes and at 50° C. for 10 minutes. The flashed-off clearcoat film was cured first with UV radiation (dose: 1500 MJ/cm²; belt speed 4 m/min). Subsequently, the aqueous basecoat film and the clearcoat film were cured in a convection oven at 150° C. for 30 minutes.

The multicoat system of the invention had a gloss of 89.2 to DIN 67530 and a micropenetration hardness of 86.5 N/mm² (universal hardness at 25.6 mN, Fischersope 100 V with diamond pyramid in accordance with Vickers).

The scratch resistance of the multicoat system was determined by the sand test. For this purpose, the film surface was loaded with sand (20 g of quartz silver sand, 1.5-2.0 mm). The sand was placed in a beaker (with its base cut off level) which was attached firmly to the test panel. The panel, with the beaker and the sand, was set in shaking movements by means of a motor drive. The movement of the loose sand caused damage to the film surface (100 double strokes in 20 s) . After sand exposure, the test area was cleaned of abraded material, wiped off carefully under a jet of cold water, and then dried with compressed air. The gloss was measured to DIN 67530 before and after damage (measurement direction perpendicular to the direction of scratching):

initial 89.2

after damage: 74.8

2 h at 60° C.: 84.4

In addition, the scratch resistance was determined by the brush test as well. For this test the test panels bearing the multicoat system was stored at room temperature for at least 2 weeks, before the test was carried out.

The scratch resistance was assessed with the aid of the BASF brush test described in FIG. 2 on page 28 of the article by P. Betz and A. Bartelt, Progress in Organic Coatings, 22 (1993), pages 27-37, which was modified, however, in respect of the weight used (2000 g instead of the 280 g specified therein), assessment taking place as follows:

In the test, the film surface was damaged using a weighted mesh fabric. The mesh fabric and the film surface were wetted generously with a laundry detergent solution. The test panel was moved backward and forward in reciprocating movements under the mesh fabric by means of a motor drive.

The test element was an eraser (4.5×2.0 cm, broad side perpendicular to the direction of scratching) lined with nylon mesh fabric (No. 11, 31 μm mesh size, Tg 50° C.). The applied weight was 2000 g.

Prior to each test the mesh fabric was replaced, with the running direction of the fabric meshes parallel to the direction of scratching. Using a pipette, approximately 1 ml of a freshly stirred 0.25% strength solution of Persil was applied in front of the eraser. The rotary speed of the motor was set so that 80 double strokes were performed in a period of 80 s. After the test, the remaining washing liquid was rinsed off with cold tap water and the test panels were blown dry using compressed air. A measurement is made of the gloss DIN 67530 before and after damage (measurement direction perpendicular to the direction of scratching):

initial: 89.2

after damage: 79.1

2 h at 60° C.: 87.7

The chemical resistance was determined using the MB gradient oven test, which is known to those skilled in the art. In this test, 1% sulfuric acid showed initial marking at 50° C., pancreatin at 44° C., and deionized water only above 75° C.

The experimental results demonstrate the outstanding optical properties, the high scratch resistance, and the high chemical resistance of the multicoat system.

### Example 3

### The Production of a Clearcoat System of the Invention

To produce the clearcoat system, the clearcoat material of Example 1 was applied to glass plates using a 100 μm box-type coating bar and cured as follows:

Method 1:

Flash-off: 10 min at room temperature, 10 min at 50° C.

UV radiation curing: dose: 1500 mJ/cm²; belt speed 4 m/min

Heat-curing: 30 min at 150° C.

Method 2:

Flash-off: 10 min at room temperature, 10 min at 50° C.

Heat-curing: 30 min at 150° C.

UV radiation curing: dose: 1500 mJ/cm²; belt speed 4 m/min

The resultant clearcoats were subjected to colorimetry by the Cielab method against a standard (uncoated glass plate against white background). In parallel with this, the Konig pendulum hardness was measured. The results are given in the table.

TABLE
Colorimetric data and pendulum hardness

| | | | | | König pendulum hardness |
|---|---|---|---|---|---|
| Method | ΔE | L* | a* | b* | (s) |
| 1 | 4.94 | 92.91 | −2.55 | 5.96 | 126 |
| 2 | 1.31 | 93.56 | −2.08 | 2.24 | 161 |

The results demonstrate that the subsequent curing with actinic light leads to harder and less yellowish and greenish clearcoats.

What is claimed is:

1. A one-component system curable with both heat and actinic radiation, comprising
(A) at least one crosslinking agent whose molecule contains on average at least one blocked isocyanate group and at least one functional group having at least one bond which may be activated with actinic radiation, and
(B) at least one binder whose molecule contains on average at least one isocyanate-reactive functional group.

2. The system as claimed in claim 1, characterized in that the binder (B) contains on average per molecule at least one functional group having at least one bond which may be activated with actinic radiation.

3. The system as claimed in claim 1 or 2, characterized in that the crosslinking agent (A) is preparable by reacting a polyisocyanate having a functionality of at least 2.0 with
at least one compound containing at least one isocyanate-reactive functional group and at least one bond which may be activated with actinic radiation, and
at least one blocking agent for isocyanate groups.

4. The system as claimed in any of claims 1 to 3, characterized in that the polyisocyanate contains isocyanurate, biuret, allophanate, iminooxadiazinedione, urethane, urea, carbodiimide and/or uretdione groups.

5. The system as claimed in any of claims 1 to 4, characterized in that said isocyanate-reactive functional groups are thiol, hydroxyl and/or primary and/or secondary amino groups.

6. The system as claimed in any of claims 1 to 5, characterized in that carbon-hydrogen single bonds or carbon-carbon, carbon-oxygen, carbon-nitrogen, carbon-phosphorus or carbon-silicon single bonds or double bonds are used as bonds which may be activated with actinic radiation.

7. The system as claimed in any of claims 1 to 6, characterized in that carbon-carbon double bonds are used.

8. The system as claimed in any of claims 1 to 7, characterized in that the double bonds are present as (meth)acrylate, ethacrylate, crotonate, cinnamate, vinyl ether, vinyl ester, dicyclopentadienyl, norbornenyl, isoprenyl, isopropenyl, allyl, or butenyl groups; dicyclopentadienyl ether, norbornenyl ether, isoprenyl ether, isopropenyl ether, allyl ether, or butenyl ether groups; dicyclopentadienyl ester, norbornenyl ester, isoprenyl ester, isopropenyl ester, allyl ester or butenyl ester groups.

9. The system as claimed in any of claims 1 to 8, characterized in that blocking agents used comprise
i) phenols such as phenol, cresol, xylenol, nitrophenol, chlorophenol, ethylphenol, tert-butylphenol, hydroxybenzoic acid, esters of this acid, or 2,5-di-tert-butyl-4-hydroxytoluene;
ii) lactams, such as ε-caprolactam, δ-valerolactam, γ-butyrolactam or β-propiolactam;
iii) active methylenic compounds, such as diethyl malonate, dimethyl malonate, ethyl or methyl acetoacetate, or acetylacetone;
iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxymethanol, glycolic acid, glycolic esters, lactic acid, lactic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;
v) mercaptans such as butyl mercaptan, hexyl mercaptan, t-butyl mercaptan, t-dodecyl mercaptan, 2-mercaptobenzothiazole, thiophenol, methylthiophenol or ethylthiophenol;
vi) acid amides such as acetoanilide, acetoanisidinamide, acrylamide, methacrylamide, acetamide, stearamide or benzamide;
vii) imides such as succinimide, phthalimide or maleimide;
viii) amines such as diphenylamine, phenylnapthylamine, xylidine, N-phenylxylidine, carbazole, aniline, napthylamine, butylamine, dibutylamine or butylphenylamine;
ix) imidazoles such as imidazole or 2-ethylimidazole;
x) ureas such as urea, thiourea, ethyleneurea, ethylenethiourea or 1,3-diphenylurea;
xi) carbamates such as phenyl N-phenylcarbamate or 2-oxazolidone;
xii) imines such as ethyleneimine;
xiii) oximes such as acetone oxime, formaldoxine, acetaloxime, acetoxime, methyl ethyl ketoxime, diisobutylketoxime, diacetylmonoxime, benzophenone oxime or chlorohexanone oximes;
xiv) salts of sulfurous acid such as sodium bisulfite or potassium bisulfite;
xv) hydroxamic esters such as benzyl methacrylohydroxamate (BMH) or allyl methacrylohydroxamate; or
xvi) substituted pyrazoles, especially dimethylpyrazole, or triazoles; and
xvii) mixtures of these blocking agents.

10. The system as claimed in claim 9, characterized in that said mixtures (xvii) comprise dimethylpyrazole and triazoles, malonic esters and acetoacetic esters, or dimethylpyrazole and succinimide.

11. The system as claimed in any of claims 1 to 10, characterized in that it is present as a powder slurry coating.

12. The use of the system as claimed in any of claims 1 to 11 as a coating material, adhesive, or sealing compound.

13. The use as claimed in claim 12, characterized in that said coating material is a pigmented or unpigmented coating material.

14. The use as claimed in claim 12 or 13, characterized in that said coating material is a surfacer, basecoat or solid-color topcoat or is a clearcoat.

15. The use as claimed in any of claims 12 to 14, characterized in that the coating material is employed in automotive OEM finishing, in automotive refinishing, in the coating of doors, windows or furniture, in the coating of interior or exterior constructions, or in industrial coating, including container coating, coil coating and the coating and/or impregnation of electrical components.
